(19) United States
(12) Patent Application Publication
(10) Pub. No.: US 2002/0181516 A1
(43) Pub. Date: Dec. 5, 2002

(54) Active phase tuning of DBR lasers

(76) Inventor: Kishore K. Kamath, Allentown, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/874,546

(22) Filed: Jun. 4, 2001

(51) Int. Cl. H01S 3/10

(52) U.S. Cl. 372/20

(57) ABSTRACT

A DBR laser includes at least one active phase shifting section, at least one gain section, and at least one Bragg section. The DBR laser is fine tuned by phase tuning the active phase shifting section of the DBR laser. Phase tuning the active phase shifting section by current injection provides a change in lasing wavelength opposite the change in lasing wavelength in response to tuning the Bragg section by current injection. This opposing change in wavelength reduces, and can eliminate, unwanted wavelength chirp due to crosstalk, thus improving laser performance by reducing the bit error rate (BER). Further, a DBR laser in accordance with the present invention is tunable without temperature tuning, thus providing much shorter transition times between desired wavelengths than possible with temperature tuning. Also, a DBR laser in accordance with the present invention can be operated at one temperature for all channels.

### FIELD OF THE INVENTION

The present invention relates to distributed Bragg reflector lasers and specifically to tunable DBR lasers.

### BACKGROUND

Wavelength division multiplexing (WDM) imposes new demands on laser sources employed in conjunction with optical fiber and free-space communications. One of these primary demands is the requirement for precision alignment of the source wavelength to one of the prescribed channels of a WDM system. Presently, distributed Bragg reflector (DBR) lasers are employed in such systems.

DBR lasers typically comprise several sections. DBR lasers may include a gain section, a passive phase section, and a Bragg reflector section. The passive phase section is typically integrally formed with the passive Bragg reflector section. Tuning of the laser may be accomplished by injecting electrical current into the phase and/or gain and/or Bragg reflector sections. Tuning may also be achieved by warming up or cooling down the laser, which makes slight alterations to the refractive index of the laser.

Tuning a conventional DBR laser by current injection is known to contribute to unwanted lasing wavelength modulation (referred to as wavelength chirp) in the presence of cross talk from the modulator section of the laser. Also, temperature tuning of a DBR laser limits channel switching speed. That is, tuning a DBR laser from one wavelength to another can be accomplished only as quickly as the temperature can be changed. This temperature changing process is relatively slow compared to current switching speed requirements.

Thus, a need exists for a DBR laser and tuning technique, which do not requiring temperature tuning, and do not detrimentally contribute to wavelength chirp in the presence of cross talk.

### SUMMARY OF THE INVENTION

A DBR laser includes at least one active phase shifting section, at least one gain section, and at least one Bragg section. The DBR laser is tuned by phase tuning at least one active phase shifting section of the DBR laser.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1 is a block diagram of an exemplary distributed Bragg reflector (DBR) laser in accordance with the present invention;

FIG. 2 is block diagram of a DBR laser in accordance with an exemplary embodiment of the present invention coupled to a modulator portion;

FIG. 3 is a block diagram of another exemplary embodiment of a DBR laser in accordance with the present invention;

FIG. 4 is a graph of lasing wavelength versus Bragg tuning current for an exemplary DBR laser in accordance with the present invention;

FIG. 5 is a graph of lasing wavelength versus phase tuning current for an exemplary DBR laser in accordance with the present invention; and

FIG. 6 is a block diagram of an exemplary optical transmission system in accordance with the present invention.

### DETAILED DESCRIPTION

A diode laser typically comprises a mirror at each end. A light beam is created and amplified within the laser by a pumping current source coupled to the laser. The light beam is created by stimulated or spontaneous emission over a bandwidth around a center frequency/wavelength. Some of this light is captured by the dielectric waveguide formed by the active medium. Mirrors, creating a Fabry-Perot resonant cavity reflect the guided light. The modes, corresponding to individual wavelengths, of this resonant cavity are spaced nearly equally in frequency/wavelength.

A two-part diode laser is formed by replacing one of the mirrors with a grating (e.g., Bragg grating). The grating provides a multiple reflective surface at the one end such that there are multiple spacings between the single mirror and the multiple reflective surfaces of the grating. This two part laser is know as a distributed Bragg reflector (DBR) laser and is well know to those skilled in the art. Also known in the art are three part DBR lasers comprising an active gain section, a passive phase shifting section, and a passive grating (or Bragg) section.

Three part DBR lasers (hereinafter referred to as “DBR lasers”) may be tuned to a lasing wavelength by modifying the characteristics of the DBR laser. One technique for tuning a DBR laser comprises positioning the peak reflection wavelength of the Bragg mirror(s) of the DBR laser to obtain the desired lasing wavelength. This is accomplished by changing the effective index of the grating through current injection. This process provides course tuning of the lasing wavelength and is referred to as “Bragg tuning”. Fine tuning, also referred to as phase tuning, may be accomplished by tuning the Fabry-Perot modes by changing the effective optical cavity length. This can be accomplished by changing the effective refractive index of the optical cavity. Several techniques, known in the art, have been used to change the refractive index, including adjusting the temperature of the DBR laser, changing the refractive index of the passive phase section by current injection, utilizing the quantum confined Stark effect (QCSE) in quantum wells, and utilizing the Franz-Kildysh effect in bulk waveguides.

Bragg tuning of a DBR laser results in a step function like tuning response. That is, the lasing wavelength tends to hop from one wavelength to another in a discontinuous fashion, thus providing coarse tuning of the DBR laser. Phase tuning tends to provide a more continuous tuning response (fine tuning) within a relatively small range of wavelengths centered at one of the coarsely tuned wavelengths. Thus, the DBR laser may be coarsely tuned (e.g., by Bragg tuning) to obtain a wavelength that is close to a desired wavelength, and then fine tuned (e.g., by changing the refractive index) to the desired wavelength.

One technique for tuning a DBR laser is to provide course tuning by Bragg tuning, and provide fine tuning by phase tuning. Conventionally, phase tuning is accomplished by tuning the passive phase section of the DBR laser by current injection to change the index of refraction. Bragg tuning of a DBR laser shifts the lasing wavelength toward shorter wavelengths as injected current increases. Phase tuning a passive phase section of a DBR laser by increasing the injected current also tends to shift the lasing wavelength of the DBR laser toward shorter wavelengths. Thus, both Bragg tuning and phase tuning a conventional DBR laser shift the lasing wavelength in the same direction.

One way to modulate a diode laser (e.g., a DBR laser) is to turn the drive voltage to the modulator portion of the diode laser on and off. Turning modulator drive voltage on and off (or modulating drive voltage) tends to shift the lasing wavelength during a pulse of light. Although the shift may be small, it occurs during the laser pulse, causing each pulse to contain a range of wavelengths (referred to as chirp). Each wavelength travels at a slightly different velocity, thus limiting transmission performance. If the drive signal of the modulator of a DBR laser is sensed (cross talk) by the Bragg and/or the passive phase shifting section, the chirp is increased. Thus, in a DBR laser having a passive phase shifting section, cross talk from the modulator portion of the DBR laser can increase the lasing wavelength chirp.

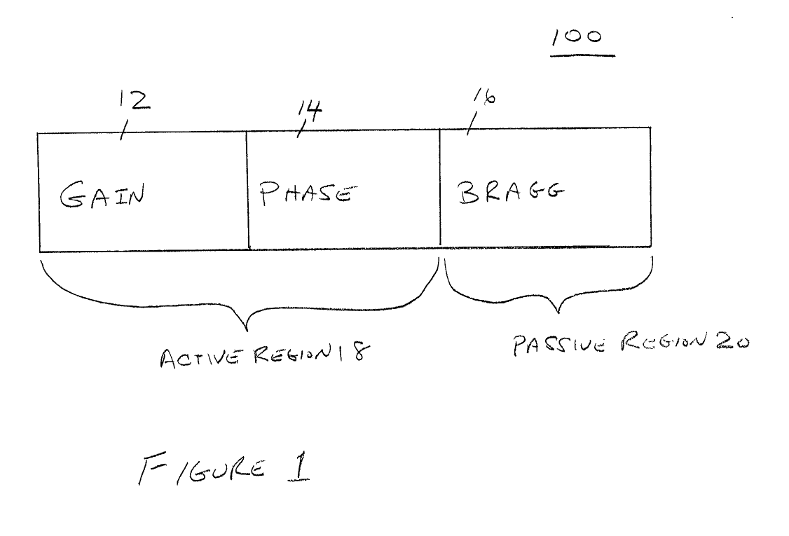

The inventor has discovered that phase tuning a DBR laser having an active phase shifting section by current injection can reduce and even eliminate wavelength chirp. In an exemplary embodiment of the invention, a phase tuning section of a DBR laser comprises an active phase tuning waveguide. This active phase tuning waveguide is similar to an active gain waveguide of a conventional DBR laser. Tuning an active waveguide (such as by current injection) effectively changes the optical loss (or gain) of the waveguide, whereas tuning a passive waveguide, effectively changes the index of refraction of the waveguide. Thus, tuning a DBR laser in accordance with the present invention, comprises phase tuning an active phase shifting section, thus changing the optical loss (or gain) of the active phase shifting section. In an exemplary embodiment of the invention, the active phase shifting section is formed from the active gain waveguide. FIG. 1 is a diagram of an exemplary distributed Bragg reflector (DBR) laser 100 in accordance with the present invention. DBR laser 100 comprises an active phase section 14, a gain section 12, and a Bragg section 16. The active region 18 of DBR laser 100 comprises gain section 12 and active phase section 14. The passive section 20 of DBR laser 100 comprises Bragg section 16. The DBR laser 100 may be phase tuned by current injection of the active phase shifting section 14. Phase tuning active phase shifting section 14 allows fine tuning of the lasing wavelength by adjusting the round trip phase of the light in the laser.

Phase tuning the active phase shifting section 14 by increasing the injection current tends to increase the lasing wavelength, which is in contrast to phase tuning a passive phase shifting section of a DBR laser by increasing the injection current, which tends to decrease the lasing wavelength. Phase tuning active phase shifting section 14 by current injection changes the cavity loss of the DBR laser 100. This loss is a result of optical absorption in the cavity. Increasing the current (i.e., by current injection) through the active phase shifting section 14 reduces the cavity loss of the DBR laser 100, which accordingly reduces the threshold gain of the laser. As is well known in the art, reducing threshold gain in a gain section reduces the carrier density in the gain section. This reduction in threshold gain tunes the lasing wavelength of the DBR laser 100 to longer wavelengths due to the reduction in carrier density in gain section 12. Thus, increasing the injection current to phase tune the active phase shifting section 14 tends to increase the lasing wavelength.

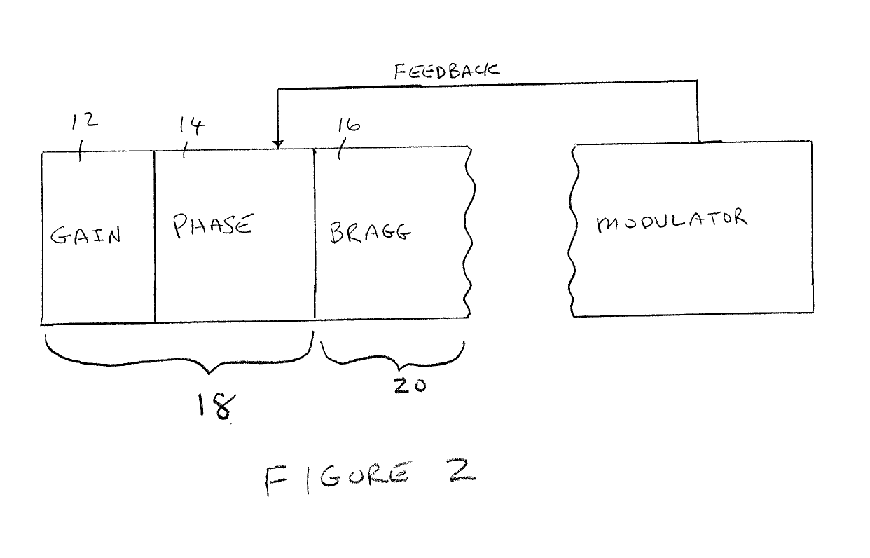

Wavelength chirp introduced by the modulation portion of the DBR laser 100, or by cross talk from the modulator to the tuning sections, is reduced by phase tuning active phase shifting section 14 by current injection. This is explained as follows. As the drive signal to the modulator portion increases, as herein explained, the lasing wavelength tends to decrease. This effect is enhanced (i.e., the wavelength tends to decrease further) if there is cross talk sensed by the Bragg section. As this increase in modulator drive current bleeds over to the active phase shifting section 14 due to cross talk, the lasing wavelength tends to increase. Thus, the cumulative affect on lasing wavelength is reduced. In an exemplary embodiment of the invention, as illustrated in FIG. 2, feedback from the modulator portion to the active phase shifting section 14 is intentionally provided to reduce wavelength chirp. By controlling the amplitude and phase of this feedback, changes in wavelength can be exactly cancelled to eliminate wavelength chirp.

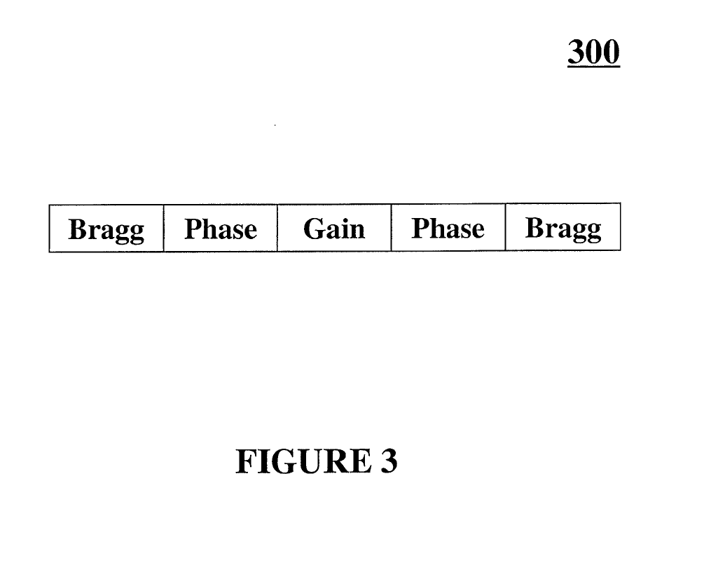

In an alternate embodiment of the invention, a DBR laser comprises at least one active phase shifting section, at least one Bragg section, and at least one gain section. FIG. 3 is a functional block diagram of another embodiment of an exemplary DBR laser 300 in accordance with the present invention. The DBR laser 300 comprises two Bragg sections, two active phase shifting sections, and a gain section. Phase tuning, as previously described herein (e.g., by current injection), of DBR laser 300 may be accomplished by tuning one or both active phase shifting sections.

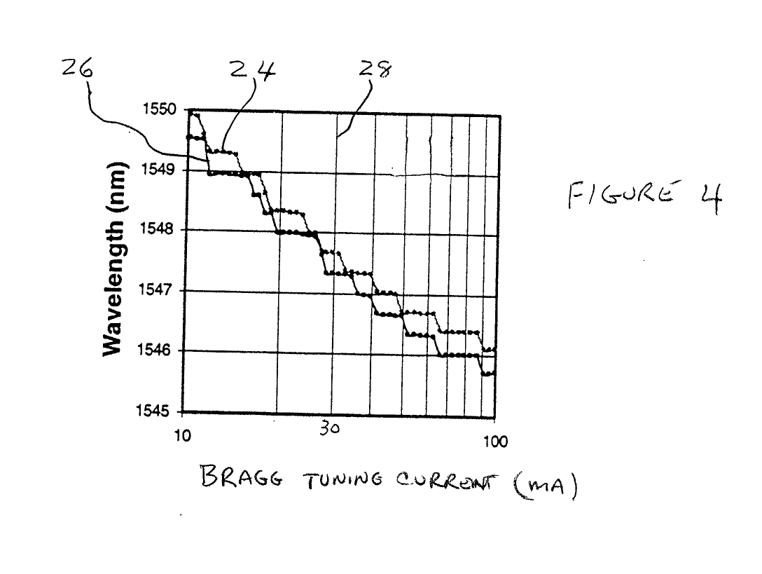

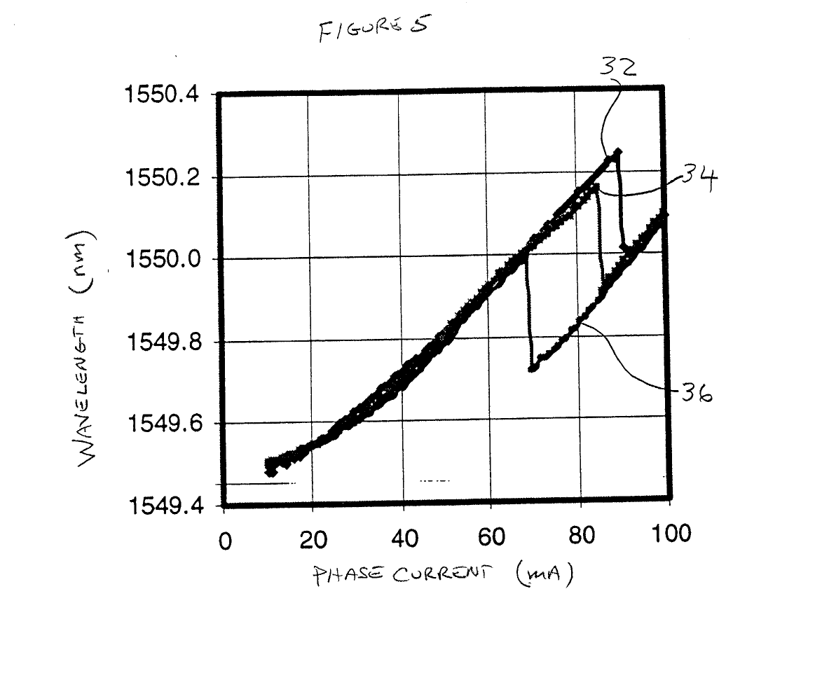

FIGS. 4 and 5 illustrate the difference in effect on lasing wavelength due to Bragg tuning and phase tuning, respectively, for a DBR laser in accordance with the present invention. FIG. 4 is a graph of lasing wavelength versus Bragg tuning current (i.e., the current injected to Bragg section 16) for an exemplary DBR laser in accordance with the present invention. For curve 24 the phase current (i.e., the current injected to active phase shifting section 14) is held constant at 60 milliamperes. The phase current is held constant at 20 milliamperes for curve 26. As the Bragg tuning current is increased, the lasing wavelength decreases in a step function like tuning response. That is, the lasing wavelength tends to hop from one wavelength to another in a discontinuous fashion. The values of lasing wavelength for curves 24 and 26 at vertical line 28 are approximately 1547.7 nanometers and 1547.4 nanometers, respectively. Vertical line 28 corresponds to a Bragg tuning current of 30 milliamperes. Note that the lasing wavelength increases as the phase current increases. That is, for a fixed value of Bragg tuning current (i.e., 30 mA), the lasing wavelength for a phase current of 20 mA is approximately 1547.4 nm, and the lasing wavelength for a phase current of 60 mA is approximately 1547.7 nm. The relationship between phase current and lasing wavelength is more clearly illustrated in FIG. 5.

FIG. 5 is a graph of lasing wavelength versus phase tuning current for an exemplary DBR laser in accordance with the present invention. For curve 32, the Bragg tuning current is held constant at 10.5 mA, for curve 34, the Bragg tuning current is held constant at 10 mA, and for curve 36, the Bragg tuning current is held constant at 9.5 mA. As phase current is increased, the lasing wavelength increases. The change in lasing wavelength is relatively small with respect to a corresponding change in phase current. However, in another embodiment of the invention, the active phase section is amplified to provide larger changes in lasing wavelength with respect to corresponding changes in phase current. As the phase current increases the lasing wavelength increases in a step function like tuning response. That is, the lasing wavelength tends to hop from one wavelength to another in a discontinuous fashion.

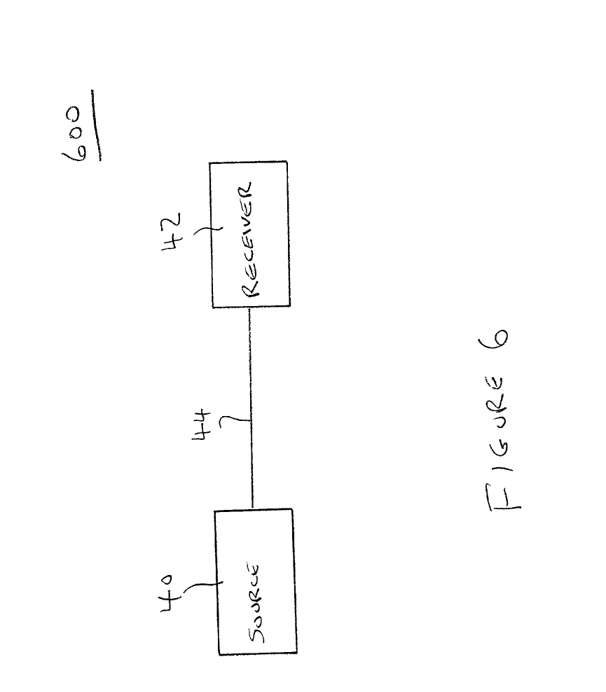

FIG. 6 is a block diagram of an exemplary optical transmission system 600 comprising a DBR laser in accordance with the present invention as the optical source 40. Optical system 600 may be any optical system such as a telecommunication system or an optical processing system, for example. System 600 comprises an optical source 40, a transmission medium 44, and a receiver 42. Optical medium 44 may be any appropriate medium, such as optical fiber, air, a vacuum, glass, and plastic, for example. The receiver 42 may by any appropriate receiver as required by the system 600. In an alternate embodiment of the invention, system 600 is part of a larger system, such as a satellite transmission system, for example.

A three section distributed Bragg reflector laser in accordance with the present invention comprises an active phase shifting section. Phase tuning the active phase shifting section by current injection provides a change in lasing wavelength opposite the change in lasing wavelength in response to tuning the Bragg section by current injection. This opposing change in wavelength reduces, and can eliminate, unwanted wavelength chirp, thus improving laser performance by reducing the bit error rate (BER). Further, a DBR laser in accordance with the present invention is tunable without temperature tuning, thus providing much shorter transition times between desired wavelengths than possible with temperature tuning. Also, a DBR laser in accordance with the present invention can be operated at one temperature for all channels, again contributing to improved performance.

Although the invention has been described in conjunction with one or more preferred embodiments, it will be apparent to those skilled in the art that other alternatives, variations and modifications will be apparent in light of the foregoing description as being within the spirit and scope of the invention. Thus, the invention described herein is intended to embrace all such alternatives, variations and modifications as may fall within the spirit and scope of the following claims.

What is claimed is:

1. A method of tuning a distributed Bragg reflector (DBR) laser comprising at least one active phase shifting section, at least one gain section, and at least one Bragg section, said method comprising the step of phase tuning at least one of said at least one active phase shifting section of said DBR laser.

2. A method in accordance with claim 1, wherein said phase tuning comprises current injection.

3. A method in accordance with claim 1, wherein said phase tuning comprises tuning by quantum confined Stark effect.

4. A method in accordance with claim 1, wherein said phase tuning comprises tuning by Franz-Kildysh effect.

5. A method in accordance with claim 1, further comprising coarse tuning by tuning said Bragg section.

6. A method in accordance with claim 5, wherein said coarse tuning comprises current injection.

7. A method in accordance with claim 5, wherein fine tuning comprises temperature tuning.

8. A method in accordance with claim 1, further comprising the step of providing feedback from a modulator portion of said DBR laser to at least one of said at least one active phase shifting section for reducing wavelength chirp.

9. A distributed Bragg reflector (DBR) laser comprising at least one active phase shifting section coupled to a gain section and a Bragg section.

10. A DBR laser in accordance with claim 9, further comprising a modulator portion, wherein feedback is provided from said modulator portion to at least one of said at least one active phase shifting section.

11. A distributed Bragg reflector (DBR) laser comprising:
at least one active gain section;
at least one Bragg section; and
at least one active phase shifting section coupled to said at least one active gain section and said at least one Bragg section, wherein course tuning of said DBR laser is provided by tuning at least one of said at least one Bragg section by current injection, and phase tuning of said DBR laser is provided by tuning at least one of said at least one active phase shifting section by current injection.

12. An optical transmission system comprising a distributed Bragg reflector (DBR) laser comprising at least one active phase shifting section coupled to at least one gain section and at least one Bragg section.

13. An optical system in accordance with claim 12, further comprising a modulator portion, wherein feedback is provided from said modulator portion to at least one of said at least one active phase shifting section.

14. An optical system in accordance with claim 12, wherein course tuning of said system is provided by tuning at least one of said at least one Bragg section by current injection, and phase tuning of said system is provided by tuning at least one of said at least one active phase shifting section by current injection.
